(19) United States
(12) Patent Application Publication
(10) Pub. No.: US 2024/0269828 A1
(43) Pub. Date: Aug. 15, 2024

(54) Decoupled Wrist-Agnostic Control for Modular Robotic Arm

(71) Applicant: Ghost Robotics Corporation, Philadelphia, PA (US)

(72) Inventor: Avik De, Philadelphia, PA (US)

(21) Appl. No.: 18/438,939

(22) Filed: Feb. 12, 2024

Related U.S. Application Data
(60) Provisional application No. 63/484,488, filed on Feb. 11, 2023.

(51) Int. Cl. B25J 9/08; B25J 9/04; B25J 9/16

(52) U.S. Cl. CPC B25J 9/08; B25J 9/046; B25J 9/1612

(57) ABSTRACT

A control mechanism of a robotic arm that is modular and applicable to a mobile robotic base with an arm is disclosed. The control of the tool actuators, the wrist actuators, and the actuators that manage the proximal arm actuators are executed hierarchically and in a manner that is minimally dependent on the end-effector itself. The robotic arm implements the modular mechanical coupling to a wrist module, which may include an active revolute wrist with two or three actuators that enable active control of the orientation of end-effectors such as a gripper designed to grasp objects, a gimbal that maintains level orientation of a camera, a hose, a spraying attachment, a screwdriver attachment, and a hammer attachment.

### PRIORITY CLAIMS

This application claims the benefit of U.S. Provisional Application Ser. No. 63/484,488 filed Feb. 11, 2023, the contents of which are incorporated herein by reference.

### BACKGROUND OF THE INVENTION

Robotic manipulation is used in several application domains where a tool needs to interact with, or be placed near, an object. Such a tool placed at the distal portion of a robotic manipulator is referred to as an “end-effector”. In different application areas, the end-effector may be quite different in terms of size or weight and may also require a different number of degrees of freedom to be actuated.

Conventionally, algorithms for control of the manipulator are reliant on an exact description of the kinematics and dynamics of the manipulator. Additionally, in the context of a mobile manipulator, where the manipulator is mounted on a mobile robot, the algorithms to control the manipulator are usually very complex. Due to these reasons, the control algorithms are very specifically designed for the specific morphology of the end-effector, and changes to the end-effector necessitate changes in the algorithm. This precludes the possibility of the end-user of the robotic mobile manipulator modifying the end-effector to suit their needs.

The need for end-effector modularity has given rise to several emerging and existing standards for mechanical and electrical interfaces, though the equivalent does not exist for the control algorithms.

Algorithms for robotic manipulator control in the context of tasks that may need position and force control are complex. This holds even more so for algorithms on a mobile manipulator that need to coordinate the end-effector force and position with the motion of the base. Previous adaptations have allowed for end-user entry of parameters to modify the control algorithm, but for less a specific robotic system with soft actuators and variable kinematic structures. In contrast, a method to control a rigid three-DoF robot manipulator base and two or three DoF revolute end-effector such that it can be adapted to the installed end-effector by an end-user is necessary. For the modification to be simply performed by the user, only a few parameters should need to be adjusted, and the control algorithm should be able to execute the user-specified control goals with the user-installed end-effector.

### SUMMARY OF THE INVENTION

The invention includes a control algorithm for the mobile manipulator system, designed to be modular with respect to the end-effector. The control algorithm enables the invention to adapt to different size and weight of end-effector, as well as adjust to the different control objectives for the end-effector, without needing any changes to the algorithm except for parameter modifications. This allows the end-user to swap end-effectors without needing reprogramming of the control algorithm. Other conventional methods may assume control of the arm base actuators in conjunction with the wrist actuators and have task objects, including positioning and orientation control of the wrist. Under this example, the control objects are kept separate to promote modularity. The structure of the modular controller results in a simpler control algorithm than a monolithic one, which reduces computational cost.

It can apply to a robotic arm with three or more arm-base actuators configured to enable positioning of the end-effector in three Cartesian dimensions. The end-effector itself may have several wrist actuators (up to three) to control the orientation of the tool, and a tool actuator. The disclosed method applies to the control of these actuators in a hierarchical and modular method. The robotic arm may have a modular mechanical coupling so that tools can be attached to the wrist.

The method can also apply to a mobile robot base equipped with an arm. The mobile base may be a legged robot that is able to control the position and orientation of its torso. The disclosed method applies to the control of the actuators in the legged robot's legs together with the three or more proximal arm actuators. The arm may have end-effector modules as described above.

In one application, the end-effector is a wrist with three revolute joints and a gripper. In this application, the control of the wrist actuators is decoupled from the control of the actuators that control the proximal arm actuators. In particular, the joints of the wrist may be configured in a yaw-pitch-roll (YPR) configuration, or a roll-pitch-roll (RPR) configuration. In both cases, the first two wrist joints can be used to control the pan and tilt angles of the distal joint.

The benefit of the disclosed method is the modularity in the control of the arm, such that the control method can be modular to the end-effector attachment itself. For the example end-effectors described above as well as others, the control method may need little or no modification. When end-effectors are installed, it is assumed that the user can set user-modifiable parameters to do with the geometry of the tool attachment (transformation from the most distal wrist actuator to the tool frame), and the end-effector mass and size (FIG. 4). Additionally, irrespective of the end-effector, the user can specify a goal in terms of the desired position and orientation of the tool, desired force to apply with the tool, or commands to the tool actuator. The load force applied on the arm can be estimated by using an observer algorithm with knowledge of the mass of the interchangeable end-effector. The size of the end-effector can be incorporated in the algorithm for self-collision avoidance to avoid the end-effector colliding with the robot body.

Another benefit of the present invention is that the wrist and tool actuators can have different impedance characteristics than the arm base actuators. For example, the arm base may have quasi-direct-drive force-controlled actuators with no compliance, but the end-effector may have non-back drivable position-controlled actuators. Due to the modularity of the controller, this mismatch does not have any adverse effect. The ability to use different kinds of actuators for the arm base and the end-effector further widens the variety of end-effectors that can be interchangeably used.

Non-limiting examples of end-effectors include an active revolute wrist with three actuators that enable active control of the orientation of a gripper, which can itself be actuated by one or two actuators, designed to grasp objects. It may also emulate a gimbal with two or three revolute actuators that maintains level orientation of a camera or other sensor, a laser designator that points a light source at a designated object, attached to two revolute actuators to control the pan and tilt angles of the. It can also be a device for carrying and pointing a hose that can spray water for fire suppression attached to two actuators to control the pan and tilt angles of the hose.

In another embodiment, the end-effector could support a spraying attachment for painting attached to two actuators that could control the pan and tilt angles of the sprayer, or a screwdriver attachment for fastening bolts and other fasteners attached to two actuators to control the pan and tilt angles of the screwdriver, along with the screwdriver's actuator to control the rotation along the tool axis. Other exemplary end-effectors can be a hammer attachment for hammering nails attached to two actuators to control the pan and tilt angles of the hammer head as it is positioned at the nail head, and an appendage without any wrist actuators for positioning a tool such as a spectroscopy or chemical sensing tool for detecting hazardous materials near objects, or for non-prehensile pushing of objects.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF DRAWINGS

FIG. 1 shows an example robotic arm on a mobile robot base.

FIG. 2 shows three end-effector configurations on a robotic arm with different numbers of degrees of freedom (DoF).

FIG. 3 shows two configurations of a three-DoF wrist, and yaw-pitch-roll (YPR) configuration and roll-pitch-roll (RPR) configurations.

FIG. 4 shows the physical effect of different user-modifiable parameters in the algorithm, including an end-effector radius affecting collision avoidance with the robot base, end-effector payload mass, and the tool frame transformation from the most distal wrist joint.

FIG. 5 show a modular and hierarchical method for controlling the position and orientation of the end-effector, taking in user-modifiable parameters and user-specified goals that can apply to different end-effectors without needing modifications to the algorithm.

FIG. 6 is an exemplary embodiment utilizing the hierarchical method for controlling the position and orientation of the end-effector.

### DETAILED DESCRIPTION OF THE INVENTION

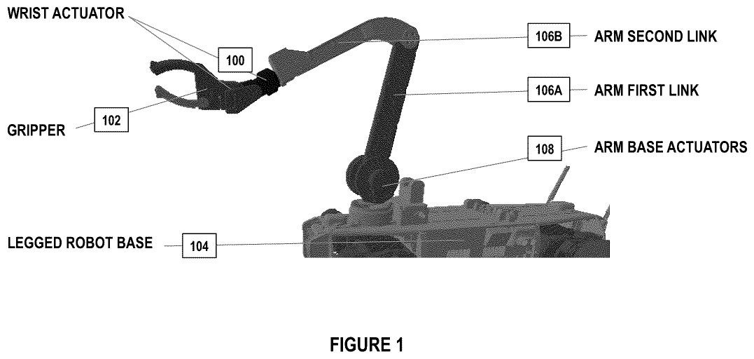

The disclosed control method in FIGS. 1-6 is hierarchical and modular.

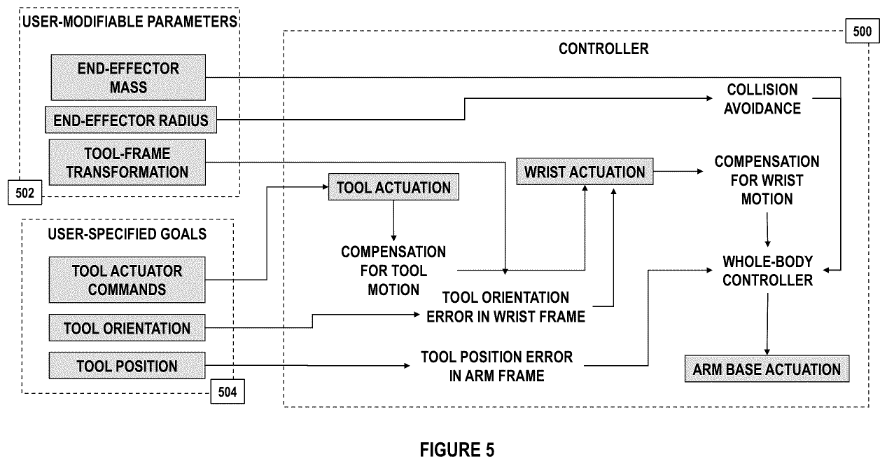

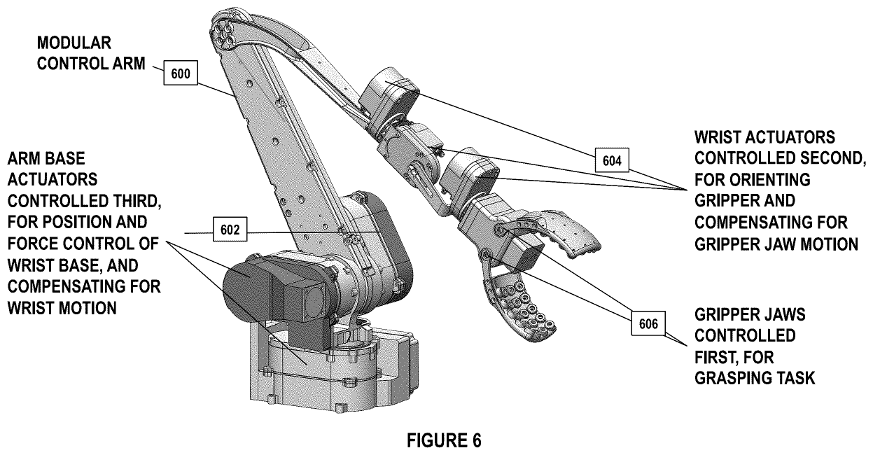

Depicted in FIG. 1, the system may include joints connected to the robot base 104, proximally to distally in the order of arm-base actuators 108, wrist actuators 100, and tool actuators 102. The user-specified goal is assumed to be positioning or force application with the tool. As shown in FIGS. 5, 6, the method may proceed to control these joints in the reverse order, first executing commands with the tool actuator 102, then the wrist actuators 100, and last the arm-base actuators 108, simultaneously with robot base actuators (not shown) if the arm is mounted on a mobile robot base 104. The structure of the hierarchical controller allows for a simpler control algorithm in each stage of the hierarchy, resulting in lower computational cost. The first (tool actuation) stage does not consider the state of the robot base 104, arm base, or wrist. The second (wrist actuation) stage does not consider the state of the robot base or arm base, and only incorporates compensation for the tool motion. The third (arm base actuation) stage only considers the arm base states and incorporates compensation for wrist motion. If the arm is attached to a mobile robot such as a quadruped, then the final stage may be a whole-body controller that recruits the leg actuators along with the arm base actuators to control the position of and force applied at the base of the wrist, along with objectives to control the torso as desired.

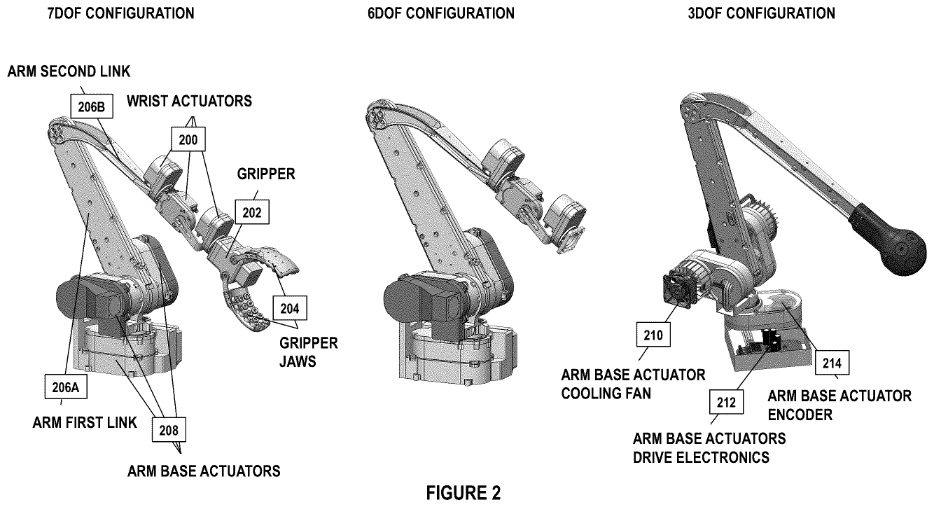

As disclosed in FIG. 2, the robotic arm shown in the seven degrees of freedom configuration features wrist actuators 200, a gripper 202 with jaws 204, a first arm link 206A and a second arm link 206B that is affixed to the arm base actuators 208. The second figure additionally showcases an example of an embodiment that can support a hose attachment with two actuators, which incorporates six degrees of freedom. Displayed in the three-degree of freedom configuration, the arm may also feature an arm base actuator cooling fan 210, arm base actuator drive electronics 212, and an arm base actuator encoder 214. If the end-effector does not have tool actuators, the first stage of the method may be skipped. If the end-effector does not have tool or wrist actuators, the first two stages of the method may be skipped.

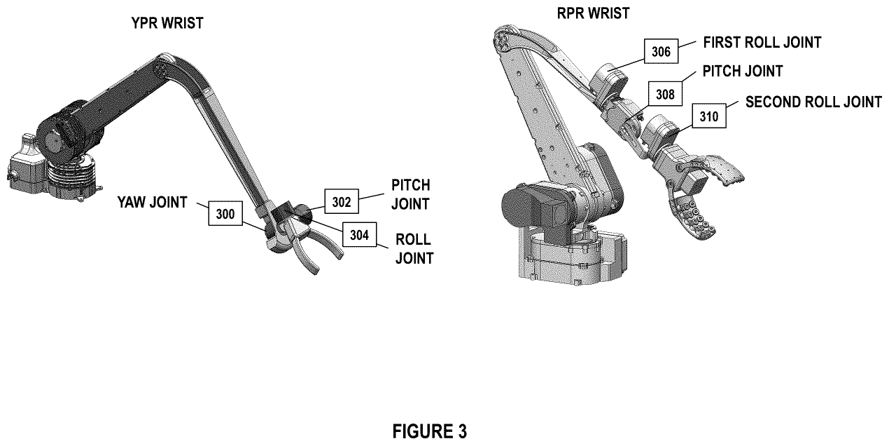

In FIG. 3, if wrist actuators are present, assume that the first two or three revolute joints share the same kinematic structure as the first two or three joints in the yaw-pitch-roll (YPR) configuration, or a roll-pitch-roll (RPR) wrist. The YPR wrist has a yaw joint 300, a pitch joint 302, and a roll joint 304. The RPR wrist has a first roll joint 306, a second roll joint 310, and a pitch joint 308.

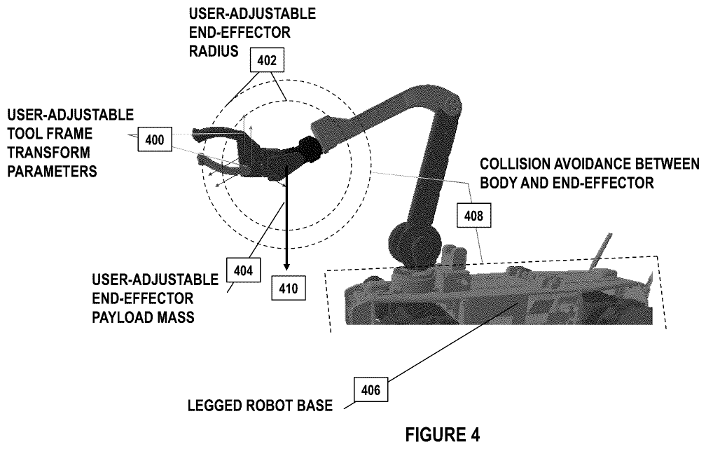

FIG. 4 shows the physical effect of different user-adjustable tool frame transform parameters 400 in the algorithm, including an end-effector radius 402 affecting collision avoidance 408 with the robot base 406, the user-adjustable end-effector payload mass 404, and the tool frame transformation 400 from the most distal wrist joint 410.

Disclosed in FIG. 5 are kinematic parameter differences between the wrist and the other end-effectors since parameter changes can be easily accomplished by the end-user via a user interface which assist with user-specified goals 504. User modifiable parameters 502 are incorporated into the algorithm. In the example of the active revolute wrist end-effector with a gripper, with an example user-specified goal 504 of grasping an object; to position the gripper in a pre-grasp position, a conventional controller 500 may solve a high-dimensional inverse kinematics problem to derive required arm joint angles, and then solve a whole-body controller problem to decide on required joint torques. Both steps must be different for each possible end-effector, complicating and adding complexity to the controller. In contrast, in the invention modular controller of the present disclosure, the controller uses the steps described below:

Based on a user-specified goal 504 of ascertaining a pre-grasp pose with the gripper, run a controller 500, which may by way of example and not limitation includes a plurality controller types such as a servo controller. The controller 500 first controls the tool actuator, which in this case is the gripper actuator. Based on the motion of the gripper jaws, the process calculates the required compensation required by the wrist actuators to establish the desired wrist orientation. Second, the process sets the orientation of the gripper as desired in the world frame in the wrist actuation stage, compensating for the gripper jaw motion. Both of the previous steps can be done with position-controlled actuators as well as velocity or torque-controlled wrist actuators. The controller 500 does not need to solve a high-dimensional inverse kinematics problem and instead only reasons about the wrist orientation. The process can solve a forward kinematics problem to derive the desired translational velocity, acceleration of the wrist base by way of a calculated velocity and acceleration to compensate for wrist motion. Lastly, the process can then solve a whole-body controller problem to decide on required joint torques to ascertain the desired translational acceleration of the wrist base. The kinematics problems that need to be solved for the compensation terms depend on the end-effector geometry only and can be specified with parameters that can be modified by the user.

The controller 500, user-modifiable parameters 502, and user-specified goals 504 can be used to ascertain the user-specified goal with the combination of the robot base and arm base.

In the example of a hose for spraying water attached to two actuators as depicted in the center figure embodiment in FIG. 2, the steps to solve problems with a modular controller include running a servo type controller 500 with the wrist actuators that sets the pan/tilt angles of the hose (two revolute degrees of freedom, “roll” along the hose does not need to be controlled), compute the compensation for wrist motion as before and solve the whole-body control problem for arm base actuation.

FIG. 6 is an exemplary embodiment utilizing the hierarchical method for controlling the position and orientation of the end-effector of a modular control arm 600, which in the direct instance are gripper jaws 606. The gripper jaws 606 are controlled first to execute the grasping task. The step including the wrist actuators 604 of the modular arm 600 are controlled second. The arm base actuators 602 are then controlled third, for position and force control of the wrist base and compensate for the wrist motion.

Various sensors, including but not limited to vision, proximity, and others, located on or near the robot, may be employed in the method of the invention of the present disclosure to provide input and feedback for calibration, operation, and movement of the robot, the robot arm, end-effector and tools.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A robot with a modular control system associated with an end-effector comprising;
a mobile robotic arm base coupled to a robotic arm comprising two or more arm links;
a first robotic arm link coupled to said mobile robotic arm base and controlled by a first robotic arm link actuator;
a second robotic arm link coupled to said first robotic arm link and controlled by a second robotic arm link actuator;
an end-effector coupled to a distal portion of said mobile robotic arm and controlled by an end-effector actuator; and
a whole-body controller, configured to receive a plurality of user parameters for using sensing data retrieved from a plurality of sensors associated with the end-effector for actuating an end-effector tool coupled to the end-effector.

2. The robot of claim 1, wherein at least two actuators operate independent of each other.

3. The robot of claim 1, wherein said end-effector comprises an active revolute wrist with a plurality of actuators that enable active control of an orientation of a gripper.

4. The robot of claim 1, wherein said robotic arm is associated with a tool for non-prehensile pushing of objects.

5. The robot of claim 1, wherein a user of said robot provides said whole-body controller with parameters for actuator orientation.

6. The robot of claim 1, wherein said user parameters comprise end-effector mass, end-effector radius, and tool-frame transformation parameters.

7. The robot of claim 1, wherein said robotic arm is enabled for three directions of movement including a yaw-pitch-roll configuration.

8. A method for a robotic modular control system associated with an end-effector comprising;
coupling a mobile robotic arm base to a robotic arm, wherein said robotic arm comprises two or more arm links;
coupling a proximal portion of a first robotic arm link and controlled by a first robotic arm link actuator to said robotic arm base;
coupling a proximal portion of a second robotic arm link and controlled by a second robotic arm link actuator to a distal portion of said first robotic arm link;
coupling an end-effector controlled by an end-effector actuator to a distal portion of the second robotic arm link;
configuring a whole-body controller to receive a plurality of user parameters for using sensing data retrieved from a plurality of sensors associated with the end-effector; and
executing an actuating movement of an end-effector tool coupled to the end-effector.

9. The method of claim 8, wherein at least two actuators operate independent of each other.

10. The method of claim 8, wherein said end-effector includes an active revolute wrist with a plurality of actuators that enable active control of an orientation of a gripper.

11. The method of claim 8, wherein said robotic arm is associated with said end-effector tool for non-prehensile pushing of objects.

12. The method of claim 8, wherein a user of said robot provides a whole-body controller with parameters for actuator orientation.

13. The method of claim 8, wherein said user parameters include end-effector mass, end-effector radius, and tool-frame transformation parameters.

14. The method of claim 8, wherein said robotic arm is enabled for three directions of movement including a yaw-pitch-roll configuration.

15. A robot with a modular control system associated with an end-effector comprising;
a mobile robotic arm base coupled to a robotic arm comprising two or more arm links;
a first robotic arm link coupled to the robotic arm base and controlled by a first robotic arm link actuator;
a second robotic arm link coupled to the first robotic arm link and controlled by a second robotic arm link actuator;
an end-effector coupled to the second robotic arm link and controlled by a tool actuator;
a whole-body controller, configured to receive a plurality of user parameters associated with a modular control system to effectuate movement of the actuators; and
a hierarchal actuating process for said plurality of actuators, wherein the tool actuator is controlled first during said hierarchal actuating process.

16. The method of claim 15, wherein the whole-body controller executes a collision avoidance mechanism for said robotic arm base and the end-effector using a radius of the end-effector.

17. The method of claim 15, wherein the mobile robotic arm base is compatible with the actuators.

18. The method of claim 15, wherein the user parameters received by the whole body include tool frame transform parameters.

19. The method of claim 18, wherein the tool frame transform parameters include a user-adjustable payload mass for the end effector.

20. The method of claim 15, wherein the whole-body controller is a servo controller.
